(19) United States
(12) Patent Application Publication
(10) Pub. No.: US 2009/0110862 A1
(43) Pub. Date: Apr. 30, 2009

(54) APPLICATOR DEVICE AND METHOD FOR MAKING

(76) Inventor: Anthony Karg, Los Angeles, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/257,286

(22) Filed: Oct. 23, 2008

Related U.S. Application Data
(60) Provisional application No. 60/983,529, filed on Oct. 29, 2007.

(51) Int. Cl. B32B 37/12; B32B 7/12; B32B 38/14; B32B 38/04; B32B 3/10

(52) U.S. Cl. 428/41.8; 428/354; 428/195.1; 156/306.6; 156/277; 156/250

(57) ABSTRACT

The invention relates to an applicator for removably attaching a napkin to a substrate. The applicator includes a first adhesive layer, a facing layer, a second adhesive layer, a liner, and an overlaminate layer. The invention also relates to a method of making an applicator for a napkin.

### CROSS-REFERENCE TO RELATED APPLICATION

This application claims the benefit of U.S. Provisional Patent Application No. 60/983,529, filed Oct. 29, 2007, the disclosure of which is hereby expressly incorporated by reference in its entirety, and priority from the filing date of which is hereby claimed under 35 U.S.C. §119.

### BACKGROUND

Garment protectors, such as napkins, bibs, dental bibs, aprons, and the like are known and widely used. Conventional napkins, for example, are typically placed on the user's lap during meals, and not only protect the user's garment directly, but also provide a convenient target for wiping the user's hands, thereby preventing the user from inadvertently soiling garments indirectly. It is very common for such garment protectors to be made as disposable items, to minimize production costs, and avoid issues relating to cleaning.

Typical disposable napkins, however, have several disadvantages in many instances. For example, it is very common for napkins to fall off the user's lap, even during indoor dining. Oftentimes, disposable napkins are used outdoors, where wind and other outdoor conditions may further induce the napkin to fall from the user's lap. Also, oftentimes the user may desire to protect a garment portion that is vertically disposed, such as the front of the user's shirt or jacket. Conventional napkins are not well-suited to protect the front of the user, requiring the user to either hold the napkin in place, or perhaps tuck an edge of the napkin into a collar, pocket, or the like.

In order to overcome the latter disadvantage, it has been proposed to include an adhesive portion on a disposable napkin, wherein a removable cover is placed over the adhesive portion, and removed prior to affixing the napkin in a desired position. Such a napkin is disclosed, for example, in U.S. Pat. No. 6,079,048, issued to Campbell, which is hereby incorporated by reference in its entirety. A disadvantage of this type of napkin is that the removable cover must be disposed of, and can result in undesirable clutter and/or nuisance to the user.

It has also been proposed to attach a reinforcement strip to a paper napkin, such as a strip of tear-resistant paper or plastic, wherein a portion of the reinforcement strip is provided with an adhesive and other portions are not, such that the napkin can be folded to place non-adhesive portions of the reinforcement strip over the adhesive portions. This allows a user to unfold the napkin to expose the adhesive portions. Such a napkin is disclosed in U.S. Pat. No. 5,476,697, issued to Bellander, which is hereby incorporated by reference in its entirety. Napkins of this type have disadvantages in that unfolding the napkin may expose the adhesive areas even if a user does not desire to use the adhesive portion of the napkin. Also, the reinforcement strip may undesirably be exposed even if a user decides to use the napkin in a conventional manner, which may interfere with the use of the napkin. It is also believed to be more expensive to manufacture napkins with such a reinforcement strip.

Therefore, there remains a need for disposable napkins and other disposable garment protectors having one or more adhesive portions that once applied to napkins, do not require the user to remove a separable cover from the adhesive portions.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention relates generally to garment protectors, and more specifically to disposable protectors that may be temporarily adhered to the garments. This new napkin design does not require the user to peel away separable pieces from the napkin, which would result in undesirable clutter and annoyance to the user.

In one aspect, the invention relates to an applicator for removably attaching a napkin to a substrate. The applicator includes:

(a) a first adhesive layer;

(b) a facing layer disposed over the first adhesive layer;

(c) a second adhesive layer disposed over the facing layer and opposite from the first adhesive layer;

(d) a liner disposed over the second adhesive layer, wherein a distal edge of the liner is substantially flush with a distal edge of the facing layer and extends beyond the second adhesive layer, forming a tab; and

(e) an overlaminate layer disposed over the liner and fixed to an end of the facing layer that is opposite the tab.

In one embodiment, the first adhesive layer is a permanent adhesive applied in full gum.

In one embodiment, the facing layer is 50# EDP paper.

In one embodiment, the second adhesive layer is a permanent adhesive applied in partial gum such that the outer edge portions of the facing layer are not covered with the second adhesive layer.

In one embodiment, the liner is 40# CIS paper having a non-adhesive coated face, and the non-adhesive coated face is downwardly disposed against the second adhesive layer.

In one embodiment, the tab is suitable for grasping and lifting the liner away from the second adhesive layer, thereby exposing the second adhesive layer.

In one embodiment, the overlaminate layer is a polymeric material.

In one embodiment, the liner is printed with a desired indicia prior to application of the overlaminate layer.

In one embodiment, the applicator has a lower liner having a non-adhesive coated face that is removably attached to the first adhesive layer, opposite the facing layer.

In one embodiment, the applicator is affixed to a napkin.

In one aspect, the invention relates to a napkin having at least one applicator for removably attaching the napkin to a substrate.

In another aspect, the invention relates to a method of making an applicator for a napkin. The method includes:

(a) providing a tape;

(b) providing a carrier liner on top of the tape, wherein the carrier liner has a siliconized upper surface;

(c) providing a first adhesive layer in full gum over the carrier liner;

(d) providing a facing layer over the first adhesive layer;

(e) providing a second adhesive layer in partial gum over the facing layer;

(f) providing a second liner over the second adhesive layer, wherein the second liner has a siliconized lower surface; and

(g) providing an overlaminate layer over the second liner.

In one embodiment, prior to providing the overlaminate layer, the second liner is printed with indicia on an upper surface.

In one embodiment, the facing layer extends transversely father than the second liner such that there are extending portions of the facing layer on either side of the second liner.

In one embodiment, the second adhesive layer does not extend transversely as far as the second liner, defining opposite-disposed first gaps on either side of the second liner.

In one embodiment, the overlaminate layer is fixed to the second liner with a permanent adhesive. In one embodiment, the overlaminate layer and permanent adhesive engage an extending portion of the facing layer, forming a hinge-like attachment thereto.

In one embodiment, the applicator is cut transversely along a center line to produce two applicators.

In one embodiment, the first and second adhesive layers provide sufficient adhesion to retain a napkin to a substrate.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a plan view of a napkin with an applicator made in accordance with the teachings of the present invention;

FIG. 2 is a sketch showing a cross-sectional side view of the napkin shown with the applicator attached in FIG. 1, wherein the thickness dimensions are exaggerated to illustrate aspects of the present invention; and

FIGS. 3A, 3B and 3C illustrate a currently preferred method for manufacturing the applicator shown in FIG. 2, and provided with a peel-away liner suitable for producing stand-alone applicators that may be selectively affixed to items such as napkins, wherein FIG. 3A shows a cross-sectional end view of a portion of a roll suitable for manufacturing applicators two-across the width of the roll (with the thickness dimension exaggerated for clarity); FIG. 3B shows a cross-sectional end view similar to FIG. 3A, after trimming and attachment of the overlaminate portion; and FIG. 3C shows an individual applicator ready for use.

### DETAILED DESCRIPTION

While illustrative embodiments have been illustrated and described, it will be appreciated that various changes can be made therein without departing from the spirit and scope of the invention.

A new applicator having unique adhesive functionality and specifications is disclosed that allows a user to attach a napkin or similar product, for example, to securely retain the napkin or similar product on the user's clothing. For example, the user may want to attach the napkin to the user's lap or chest. Alternatively, the applicator of the present invention may be used to retain a napkin or similar product on an external object, such as a table or chair, to hold the napkin in place even outdoors in windy conditions. The applicator of the present invention may be co-manufactured with the napkin or similar device, to provide a stand-alone product, or may be produced as a separate product for affixing as desired on a conventional napkin or similar product. It is contemplated that the applicator may be used with conventional paper, plastic or cloth napkins by the appropriate selection of a suitable adhesive material.

The applicator may be produced with a desired indicia thereon that may be visible during use, such as a logo or other indicia associated with a restaurant, product, or promotional item. The invention's benefits include flexibility, marketing promotion appeal, reduced napkin waste and overall dining protection associated with otherwise normal dining experiences. The current embodiment of the applicator, sometimes referred to herein as the Nap-Stik™ applicator, is designed to provide the user with maximum flexibility in how and where a napkin or similar product is placed.

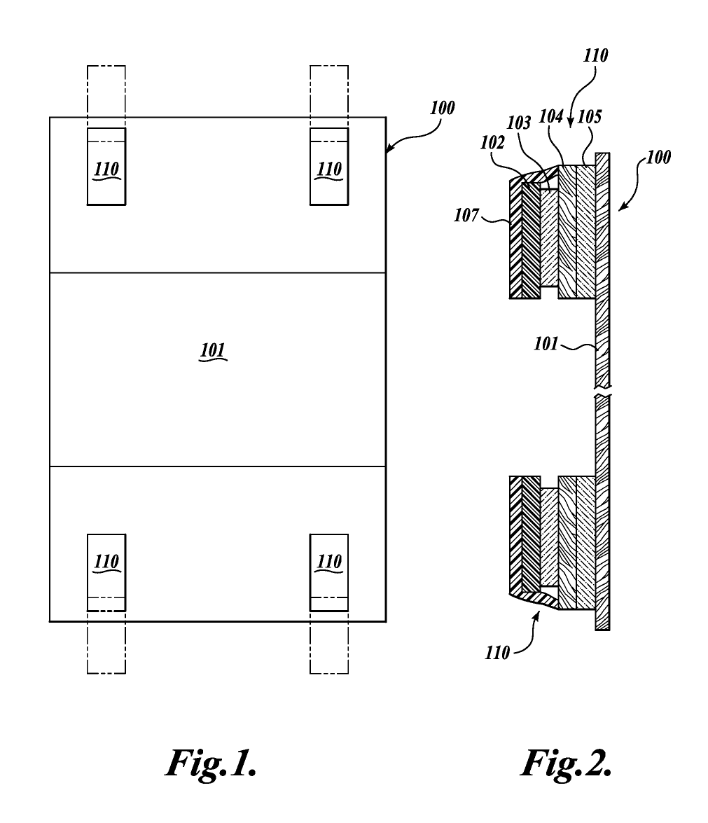

A napkin 100 having four integral Nap-Stik™ applicators 110 attached generally near the corners of the napkin 100 is shown in FIGS. 1, and 2, wherein FIG. 1 shows the napkin 100 unfolded in plan view, and FIG. 2 shows a side view with the thickness dimension greatly exaggerated to show various aspects of the applicator 110. In FIG. 1 the applicators 110 are shown non-deployed, with the deployed position shown in phantom. The napkin 100 includes a main body portion 101, which might typically be conventional paper napkin material or cloth. For example, the body of the napkin 101 may be formed in multiple layers and may include a relatively impermeable center layer, to provide enhanced protection from seep-through during use.

As indicated in FIG. 2, the applicators 110 comprise multiple layers. A first adhesive layer 105 fixes the applicator to the napkin body 101. Preferably, although not necessarily, the adhesive layer 105 is a permanent adhesive applied in full gum, for example A106™ permanent adhesive available from 3 Sigma Corporation in Troy, Ohio, U.S.A.

The second layer is a facing layer 104, which in the current embodiment comprises a 50# EDP paper, which is adhered to the napkin body 101 with the first adhesive layer 105. A second adhesive layer 103 is provided on the opposite side of the facing layer 104. In the currently preferred embodiment, the second adhesive layer comprises A106™ permanent adhesive applied in partial gum such that outer edge portions of the facing layer 104 are not covered with the second adhesive layer 103.

A liner 102 is disposed over the second adhesive layer 103. The liner 102 in the preferred embodiment is a 40# CIS paper, which has a silicon coat on one face, and wherein the silicon-coated face is disposed downwardly, against the second adhesive layer 103. The distal edge of the liner 102 is approximately flush with the distal edge of the facing layer 104, and therefore extends beyond, or overhangs, the coverage of the second adhesive layer 103. The overhang portion of the liner provides a convenient flap or tab that permits the user to pull the liner 102 away from the second adhesive layer 103, to expose the second adhesive layer 103.

A thin sheet or film overlaminate 107 is adhered over the top of the liner 102, and is adhered to one end of the facing layer 104 (opposite the tab portion of the liner 102) with a conventional permanent adhesive (not shown). The overlaminate 107 may be formed, for example, from a polymeric material such as polyester, polycarbonate, as are known in the art.

It is contemplated that prior to the application of the overlaminate 107, the liner 102 may be printed with a desired indicia (not shown), such as a company logo, a decorative design, a product endorsement, game piece or the like, such that the indicia may be visible during the intended use of the applicator 110. It is contemplated that the game piece may further include a removable panel, such that the user can view the indicia only after removing the panel.

Although the applicator 110 disclosed in FIGS. 1 and 2 is shown permanently affixed to the napkin body 101, it will be readily apparent to persons skilled in the art that the applicator may alternatively be provided with a lower liner (rather than the napkin body 101), similar to the liner 102, and wherein the liner has a silicon or other non-stick face removably attached to the first adhesive layer 105. In this alternative embodiment, a user may selectively attach the applicator to a napkin or the like, and then attach the napkin to the user.

With the applicator 110 attached to the napkin 100, a user may use the napkin 100 in the normal fashion, e.g., placing the napkin 100 on the user's lap, without exposing the second adhesive layer 103 such that the napkin 100 is not adhered to the user.

Alternatively, to avoid having the napkin 100 fall from the user's lap, the user may grasp and pull the liner 102 including the overlaminate 107, to expose the second adhesive layer 103, and press the second adhesive layer 103 against the user's lap, to retain the napkin thereon.

As a third alternative, the user may expose the second adhesive layer 103 of one or more of the applicators 110 as discussed above, and press the second adhesive layer 103 against the chest portion of the user's clothes to use the napkin 100 essentially as a bib. As yet another alternative, the second adhesive layer 103 may be exposed and secured to a table or other object, for example, to prevent the napkin 100 from blowing away during outdoor use.

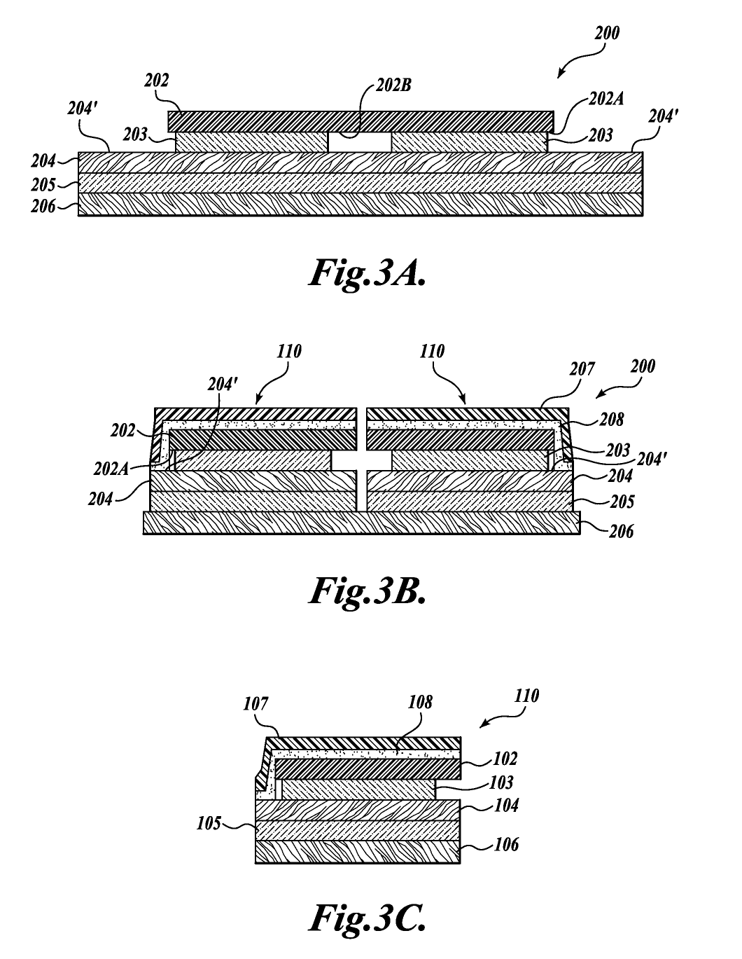

A currently preferred method for constructing the applicator 110 will now be described with reference to FIGS. 3A, 3B and 3C. It will be appreciated that the representative dimensions disclosed below are intended by way of example and not limitation, and in particular that the particular dimensions may be selected to accommodate a particular application.

In the current method the applicator is generally manufactured in a roll or tape 200 with two applicators formed across the length of the tape 200. FIG. 3A shows a cross-sectional side view of the tape 200 after the first stage of manufacture. The tape 200 includes a facing layer 204 with a lower surface having a full gum first adhesive layer 205, and an upper surface having a partial gum second adhesive layer 203 applied in two transverse strips. A carrier liner 206 underlies the first adhesive layer 205, the carrier liner 206 having a siliconized upper surface such that the carrier liner 206 can be selectively peeled away from the full gum first adhesive layer 205. A second liner 202 overlies the partial gum second adhesive layer 203, the second liner 202 having a siliconized lower surface, such that the second liner 202 can be selectively peeled away from the partial gum second adhesive layer 203.

In one embodiment, the transverse dimension of the carrier liner 206, first adhesive layer 205, and facing layer 204 is approximately 5.5 inches. In this embodiment, the transverse dimension of the second liner 202 is approximately 3.75 inches. The second liner 202 overlies the second adhesive layer 203 by approximately 0.0625 inches, thus allowing the second liner 202 to be selectively peeled away from the second adhesive layer 203.

Optionally, the second liner 202 may be printed with indicia on its upper surface, for example with a company logo, a decorative design, a product endorsement, game piece or the like. The printing may be accomplished before assembly of the tape 200, or after. In a particular example, two mirror-image indicia are printed on the second liner 202, such that the tape 200 may be cut along its centerline (and transversely) to produce two identical applicators, as will be better understood from FIGS. 3B and 3C.

As seen most clearly in FIG. 3A, facing layer 204 extends transversely farther than the liner 202, which is approximately centered over the facing layer 204, leaving extension portions 204′ of the facing layer on either side. In one embodiment, facing layer 204 extends transversely farther than the liner 202 by approximately 0.875 inches on each side. Moreover, the partial gum second adhesive layers 203 are spaced apart and do not extend transversely as far as the liner 202, defining oppositely-disposed first gaps 202A on either side of the liner 202, and a center gap 202B. In one embodiment, the second adhesive layers 203 are spaced apart approximately 0.625 inches.

Refer now to FIG. 3B, which shows the tape 200 after the attachment of an overlaminate 207 and suitable trimming of the tape 200. The overlaminate 207 is preferably transparent, or semi-transparent, and is affixed to the upper surface of the liner 202 with a conventional permanent adhesive 208. In addition, the overlaminate 207 and adhesive 208 engage the extension portions 204′ of the facing layer 204, forming a hinge-like attachment thereto. The tape 200 is trimmed, such that left and right applicators 110 are provided on a single carrier liner 206. In one embodiment, the tape 200 is trimmed such that the left and right applicators 110 are each approximately 2.0 inches wide.

It will now be appreciated that the tape 200 may be die cut, for example, transversely and along a centerline, to produce the final applicators 110, as shown in FIG. 3C.

In an aspect of the currently preferred embodiment, the first and second adhesive layers 105, 103 comprise a permanent adhesive, such that the layers provide sufficient adhesion to retain the napkin or other similar device as desired, for example affixed to the user's clothes or the like. However, the adhesive is permanent only in the sense that once it has had enough time to properly set-up, it will have reached its maximum potential adhesion. The adhesive is therefore aggressive enough to be used for this application, but because it is anticipated that the product would be retained for a limited period of time, e.g., 2-3 hours, the adhesive will not fully set up, and the user can readily remove the applicator 110 after use. The applicator 110 may readily be used, therefore, for up to 3 hours or more and can still be removed without damaging clothing.

It should also be appreciated that the partial gum application of the second adhesive layer serves two purposes. Firstly, the extension portion 204′ of the facing layer 204 is free of adhesive to provide a base layer for the hinge portion of the overlaminate 207. Secondly, the adhesive free center gap 202B forms the lift edges for the liner 202 and overlaminate 207 after the converter die cuts the finished construction.

As discussed above, it is contemplated that the applicators 110 may be pre-affixed onto napkins or the like to form a stand-alone product or may be separately packaged such that a user may selectively attach the applicator 110 to a conventional napkin or other product and then affix the napkin or other product in a desired location. Alternatively, the applicator 110 may be attached in the desired location, for example on the user's lap or shirt, and then a conventional napkin or other product attached to the applicator 110.

The selected adhesive will be of the type that will adhere to a variety of materials, including textiles, without leaving any residue. This includes the ability to slowly dry, once applied, to maximum adhesion over the standard time associated with a meal without damaging the clothing (excluding the disclaimer), in reducing potential reduction of premature release of the applicator from the users clothing. In one embodiment, the selected adhesive is A106™ permanent adhesive available from 3 Sigma Corporation in Troy, Ohio, U.S.A. A106 is a synthetic, rubber based, general purpose permanent adhesive. The adhesive coat weight is 13±2 pounds per ream (18-24.5 gsm). The minimum application temperature is +40° F. The service temperature range is −50/+150° F. Typical performance data for A106 are shown below in Table 1.

TABLE 1

| | | 180° Peel | 180° Peel | Shear |
|---|---|---|---|---|
| | Looptack | (20 min) | (24 hours) | (1 kg) |
| | (oz/in²) | (lb/in) | (lb/in) | (min/in²⁾ |
| Stainless Steel | 90 | 5.0 | 5.0 | 8400 |
| HDPE | 49 | 3.0 | 3.3 | — |
| PP | 26 | 2.6 | 3.3 | — |
| Glass | 65 | 4.4 | 4.8 | — |
| Rec. Corrugated | 41 | 2.3 | 2.5 | — |

While the preferred embodiment of the invention below has been illustrated and described, it will be appreciated that various changes in types of layout, size, shape and material can be made therein without departing from the spirit and scope of the invention.

The embodiments of the invention in which an exclusive property or privilege is claimed are defined as follows:

1. An applicator for removably attaching a napkin to a substrate, the applicator comprising:
(a) a first adhesive layer;
(b) a facing layer disposed over the first adhesive layer;
(c) a second adhesive layer disposed over the facing layer and opposite from the first adhesive layer;
(d) a liner disposed over the second adhesive layer, wherein a distal edge of the liner is substantially flush with a distal edge of the facing layer and extends beyond the second adhesive layer, forming a tab; and
(e) an overlaminate layer disposed over the liner and fixed to an end of the facing layer that is opposite the tab.

2. The applicator of claim 1, wherein the first adhesive layer is a permanent adhesive applied in full gum.

3. The applicator of claim 1, wherein the facing layer is 50# EDP paper.

4. The applicator of claim 1, wherein the second adhesive layer is a permanent adhesive applied in partial gum such that the outer edge portions of the facing layer are not covered with the second adhesive layer.

5. The applicator of claim 1, wherein the liner is 40# CIS paper having a non-adhesive coated face, and wherein the non-adhesive coated face is downwardly disposed against the second adhesive layer.

6. The applicator of claim 1, wherein the tab is suitable for grasping and lifting the liner away from the second adhesive layer, thereby exposing the second adhesive layer.

7. The applicator of claim 1, wherein the overlaminate layer is a polymeric material.

8. The applicator of claim 1, wherein the liner is printed with a desired indicia prior to application of the overlaminate layer.

9. The applicator of claim 1, further comprising a lower liner having a non-adhesive coated face that is removably attached to the first adhesive layer opposite the facing layer.

10. The applicator of claim 1, wherein the applicator is affixed to a napkin.

11. A napkin comprising at least one applicator for removably attaching the napkin to a substrate, wherein the applicator is the applicator of claim 1.

12. A method of making an applicator for a napkin, the method comprising the steps of:
(a) providing a tape;
(b) providing a carrier liner on top of the tape, wherein the carrier liner has a siliconized upper surface;
(c) providing a first adhesive layer in full gum over the carrier liner;
(d) providing a facing layer over the first adhesive layer;
(e) providing a second adhesive layer in partial gum over the facing layer;
(f) providing a second liner over the second adhesive layer, wherein the second liner has a siliconized lower surface; and
(g) providing an overlaminate layer over the second liner.

13. The method of claim 12, wherein prior to providing the overlaminate layer, the second liner is printed with indicia on an upper surface.

14. The method of claim 12, wherein the facing layer extends transversely father than the second liner such that there are extending portions of the facing layer on either side of the second liner.

15. The method of claim 12, wherein the second adhesive layer does not extend transversely as far as the second liner, defining opposite-disposed first gaps on either side of the second liner.

16. The method of claim 12, wherein the overlaminate layer is fixed to the second liner with a permanent adhesive.

17. The method of claim 16, wherein the overlaminate layer and permanent adhesive engage an extending portion of the facing layer, forming a hinge-like attachment thereto.

18. The method of claim 12, wherein the applicator is cut transversely along a center line to produce two applicators.

19. The method of claim 12, wherein the first and second adhesive layers provide sufficient adhesion to retain a napkin to a substrate.
